(19) United States
(12) Patent Application Publication
(10) Pub. No.: US 2006/0034449 A1
(43) Pub. Date: Feb. 16, 2006

(54) System and method of delivering operating power and power source status signals over a single pair of wires

(76) Inventor: Richard B. Joerger, Davie, FL (US)

Correspondence Address: LAW OFFICES OF MARK C. PICKERING, P.O. BOX 300, PETALUMA, CA, 94953, US

(21) Appl. No.: 10/796,461

(22) Filed: Mar. 9, 2004

(51) Int. Cl. H04M 9/00

(52) U.S. Cl. 379/413

(57) ABSTRACT

The subscriber end of a network, such as a Fiber-To-The-Home (FTTH) network, utilizes a pair of wires to provide both power source (battery) status information and operating power over the pair of wires by superimposing tones, which indicate the status of the battery, onto a DC voltage on the pair of wires.

### BACKGROUND OF THE INVENTION

1. Field of the Invention

The present invention relates to a communications system that has a restriction on the number of wires that are available to pass operating power and power source status signals and, more particularly, to a system and method of delivering operating power and power source status signals over a single pair of wires.

2. Description of the Related Art

The subscriber end of a Fiber-To-The-Home (FTTH) network terminates a fiber optic cable in an optical network terminal (ONT) positioned at an interior or exterior location on a subscriber's premise. As a result, a substantial amount of bandwidth can be made available to the subscriber to provide a variety of services, such as plain old telephone service (POTS), Internet access service, and television service.

One of the requirements of a POTS provider is to insure that telephone service is available for a period of time, such as eight hours, after a power failure. In an FTTH network, this is accomplished by providing a battery backup at the subscriber's premise. Thus, when power is lost, the battery backup at the subscriber's premise provides power to the ONT at the subscriber's premise to maintain the telephone service for the required period of time.

Although current-generation batteries perform for extended periods of time, even the best batteries will need to be replaced a number of times during the expected lifetime of an ONT. To insure uninterrupted service, the batteries are continuously monitored. As a result, when the performance of a battery falls below a predefined limit, the condition is detected and reported to the central office.

FIG. 1 shows a block diagram that illustrates the subscriber end of a prior-art FTTH network 100. As shown in FIG. 1, FTTH network 100 includes a twisted-pair cable 110 that has a number of pairs of wires, and a telephone 112 that is connected to a first pair of wires 110A of twisted-pair cable 110.

Twisted-pair cables are commonly installed in residential settings to provide telephone service. In many cases, particularly in older homes, the twisted-pair cable has only two pairs of wires, a first pair of wires which is used to provide telephone service and a second pair of wires which is unused.

As further shown in FIG. 1, FTTH network 100 also includes a power supply 114 that is connected to a second pair of wires 110B (the unused pair of wires) of twisted-pair cable 110. Power supply 114, which plugs into a standard AC wall outlet, converts 115 VAC into a DC voltage, such as 14V, which is placed on the second pair of wires 110B (+ to one wire, − to the other wire).

In addition, FTTH network 100 includes a battery module 116 that is connected to the second pair of wires 110B to place a lower DC battery voltage, such as 12V, on the second pair of wires 110B (+ to one wire, − to the other wire) in the event that power supply 114 can no longer provide the necessary voltage.

Battery module 116 includes a rechargeable battery 120 that, when fully charged, outputs the lower DC battery voltage (12V). Battery 120 can be implemented with any number of commercially available rechargeable batteries, such as gel packs, lithium ion, and other similar types of batteries.

Battery module 116 also includes a charge control circuit 122 that is connected to battery 120. When power supply 114 fails, charge control circuit 122 passes the lower DC battery voltage to an output node N1, which is connected to the second pair of wires 110B. On the other hand, when power supply 114 is functioning, charge control circuit 122 can recharge battery 120 by passing a current from power supply 114 to battery 120.

In addition, battery module 116 includes a voltage sensor 124 that is connected to the output node N1 to sense the magnitude of the voltage on the output node N1. Further, battery module 116 includes a controller 126 that is connected to charge control circuit 122 and voltage sensor 124. Controller 126 can be implemented with a microprocessor, or as logic implemented in, for example, a gate array or an application specific integrated circuit (ASIC). (Charge control circuit 122, voltage sensor 124, and controller 126 each receive operating power from battery 120 which, as noted above, is charged by power supply 114.)

In operation, voltage sensor 124 senses the voltage on the output node N1, and transmits a value that represents the sensed voltage to controller 126. During normal operation, voltage sensor 124 detects the voltage output by power supply 114 (e.g., 14V), and transmits a corresponding value to controller 126. In this case, controller 126 commands charge control circuit 122 to recharge battery 120 if needed.

On the other hand, when the voltage from power supply 114 is no longer available, voltage sensor 124 detects the falling voltage and transmits a value that represents the voltage to controller 126. When the falling voltage reaches a predetermined level, such as 11V, controller 126 commands charge control circuit 122 to place the battery voltage on the output node N1.

In addition to controlling the charging and use of battery 120, controller 126 also reports the status of battery 120. Controller 126 can report, for example, whether power supply 114 or battery 120 is providing a voltage to the second pair of wires 110, and whether or not battery 120 is charged or needs charging. Further, controller 126 can determine and report whether battery 120 needs replacing by measuring how long it takes for battery 120 to become charged, as well as other factors that indicate that state of battery 120.

As further shown in FIG. 1, FTTH network 100 also includes a control cable 130 that is connected to controller 126 of battery module 116, and an optical network terminal (ONT) 132 that is connected to twisted-pair cable 110 and control cable 130. (An integrated access device (IAD) or a residential gateway (RG) can be used in lieu of ONT 132.)

ONT 132 is connected to telephone 112 via the first pair of wires 110A, and to battery module 116 via the second pair of wires 110B, i.e., the unused pair of wires. Control cable 130, in turn, has a number of wires, such as seven, that provides battery status information from controller 126 to ONT 132.

ONT 132 includes a voltage sensor 134 that is connected to an input node N2, which is connected to the second pair of wires 110B, to sense the magnitude of the voltage on the input node N2. ONT 132 optionally includes a diode bridge 136 that is connected to the input node N2 to pass the voltage on the input node N2 to an interior node N3, and a last gasp circuit 140 that is connected to the interior node N3 (or input node N2 if no diode bridge 136 is used) and voltage sensor 134. (Diode bridge 136 is not used in some implementations due to the power lost from the voltage drop across the diodes of bridge 136.)

Further, ONT 132 includes a controller 142 that is connected to control cable 130, voltage sensor 134, and last gasp circuit 140. (Voltage sensor 134, diode bridge 136, last gasp circuit 140, and controller 142 each receive operating power from supply 114 or battery 120, depending on which source is functioning.)

When power supply 114 and battery 120 both fail to provide the voltage needed by ONT 132, voltage sensor 134 detects and reports this condition to last gasp circuit 140. Last gasp circuit 140, in turn, outputs a voltage to the interior node N3 for a period of time that allows controller 142 to shut down. Last gasp circuit 140 can utilize, for example, a capacitor to store a finite amount of energy to be delivered to the interior node N3. (ONT 132 can be implemented without last gasp circuit 140.)

To prevent a total loss of power, the status of battery 120 is continuously monitored. As noted above, controller 126 can output status signals that indicate, for example, whether power supply 114 or battery 120 is providing a voltage to the second pair of wires 110, whether or not battery 120 is charged or needs charging, and whether or not battery 120 needs replacing.

Controller 142 receives the battery status signals from controller 126, and passes the status information along to the central office as necessary. As a result, when battery 120 begins to fail and needs replacing, the condition can be detected and the responsible party notified before total battery failure results.

One problem with FTTH network 100, however, is that it can become quite expensive and/or inconvenient to install control cable 130 in a subscriber setting. Thus, there is a need for a method of delivering battery status information to ONT 132 that does not require the installation of additional wiring.

### SUMMARY OF THE INVENTION

The present invention provides a system and method of delivering operating power and power source status signals over a single pair of wires. Thus, when a single pair of wires is available, the present invention can deliver power and battery status information to a network terminal, such as an ONT, an IAD, or an RG, without the installation of additional wiring.

The system of the present invention includes a network with a status encoder. The status encoder has a pair of wires, and an encoding circuit that is connected to the pair of wires. The encoding circuit receives battery status information, and outputs a plurality of tones that represent the battery status to the pair of wires. The status encoder can also include a high-pass filter that is connected to the pair of wires, and connectable to a second pair of wires. The high pass filter superimposes the plurality of tones onto a DC voltage carried by the second pair of wires.

The system of the present invention also includes a network terminal that has an input node that is connectable to a pair of wires, and a voltage sensor that is electrically connected to the input node. In addition, the network terminal also includes a controller that is connected to the voltage sensor, and a status decoder that is electrically connected to the input node. The status decoder receives a plurality of tones, and outputs battery status information represented by the tones to the controller.

The present invention additionally includes a method of providing battery status information. The method includes the steps of placing a voltage on a pair of wires, and superimposing a plurality of tones on the voltage on the pair of wires. The plurality of tones represents a status of a battery, which switchably provides a voltage to the pair of wires.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block diagram illustrating the subscriber end of a prior-art FTTH network 100.

FIG. 2 is a block diagram illustrating an example of the subscriber end of a Fiber-To-The-Home (FTTH) network 200 in accordance with the present invention.

FIG. 3 is a block diagram illustrating an example of the subscriber end of a Fiber-To-The-Home (FTTH) network 300 in accordance with an alternate embodiment of the present invention.

FIG. 4 is a block diagram illustrating an example of the subscriber end of a Fiber-To-The-Home (FTTH) network 400 in accordance with an alternate embodiment of the present invention.

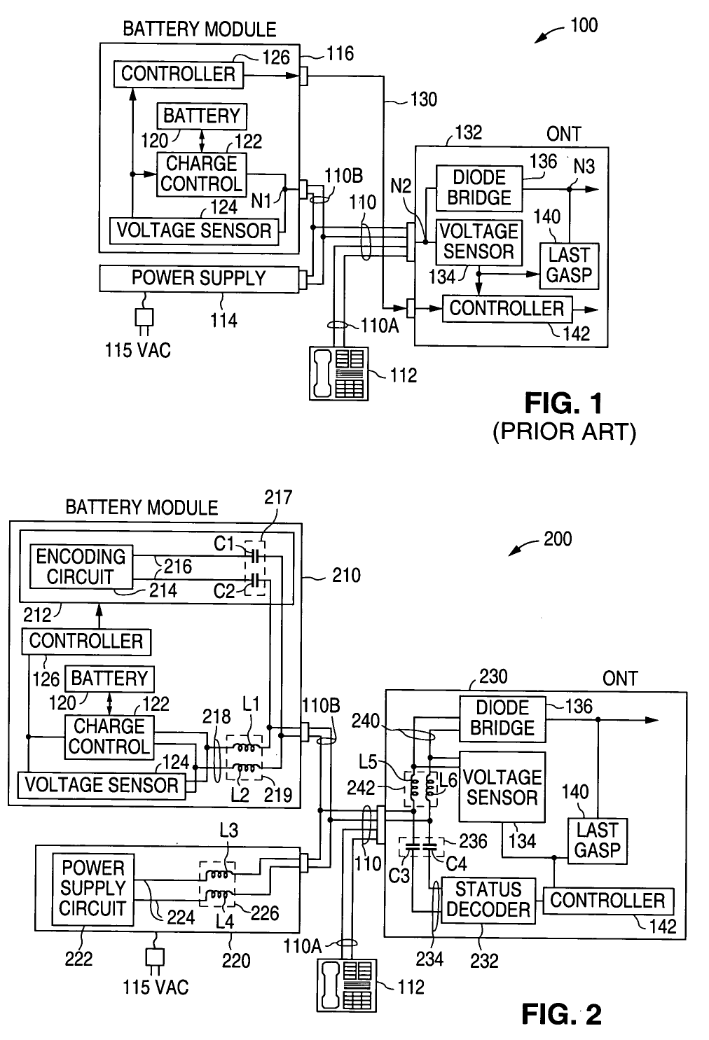

### DETAILED DESCRIPTION OF THE INVENTION

FIG. 2 shows a block diagram that illustrates an example of the subscriber end of a Fiber-To-The-Home (FTTH) network 200 in accordance with the present invention. As described in greater detail below, network 200 provides both power source (battery) status information and operating power over a single pair of wires by adding tones, which indicate the status of the battery, to a DC voltage on the single pair of wires.

Network 200 is similar to network 100 and, as a result, utilizes the same reference numerals as network 100 to designate the structures which are common to both networks. As shown in FIG. 2, one difference between network 200 and network 100 is that network 200 includes a battery module 210 that, in addition to the elements of battery module 116, includes a status encoder 212.

Status encoder 212 includes an encoding circuit 214, a first pair of intermediate wires 216 that are directly connected to encoding circuit 214, and a high-pass filter 217 that is connected to encoding circuit 214 via wires 216. High-pass filter 217 can be implemented with, for example, capacitors C1 and C2. In addition, capacitors C1 and C2 are also electrically connected to the second pair of wires 110B of twisted-pair cable 110. (Charge control circuit 122, voltage sensor 124, controller 126 and status encoder 212 receive operating power from battery 120.)

Battery module 210 also includes a second pair of intermediate wires 218 that are directly connected to charge control circuit 122 and voltage sensor 124, and a low-pass filter 219 that is connected to charge control circuit 122 and voltage sensor 124 via wires 218. Low-pass filter 219 can be implemented with, for example, inductors L1 and L2. In addition, inductors L1 and L2 are also electrically connected to the second pair of wires 110B of twisted-pair cable 110.

In operation, encoding circuit 214, which includes a look up table, receives the battery status information output by controller 126, looks up a tone that is associated with the status information, and places the tone on the first pair of intermediate wires 216. Encoding circuit 214 can place a single tone on the intermediate wires 216 or, alternately, multiple tones at the same time.

High pass filter 217, in turn, superimposes the tone or tones onto a DC voltage on the second pair of wires 110B. In addition, high pass filter 217 blocks the DC voltage on the second pair of wires 110B, thereby preventing encoding circuit 214 from receiving the DC voltage. Low-pass filter 219, in turn, blocks charge control circuit 122 and voltage sensor 124 from receiving any of the tones from the second pair of twisted wires 110B.

Another difference between the networks is that network 200 includes a power supply 220 that includes a power supply circuit 222, a third pair of intermediate wires 224 that are directly connected to power supply circuit 222, and a low-pass filter 226 that is connected to power supply circuit 222 via wires 224. Low-pass filter 226 can be implemented with, for example, inductors L3 and L4. Power supply circuit 222 converts an AC signal, such as 115 VAC, to a DC voltage, such as 14V, that is placed on the third pair of intermediate wires 224.

Low pass filter 226, which is also connected to the second pair of wires 110B of twisted-pair cable 110, passes the DC voltage from circuit 222 onto the second pair of twisted wires 110B. In addition, low pass filter 226 blocks power supply circuit 222 from receiving any of the tones from the second pair of twisted wires 110B.

Network 200 additionally differs from network 100 in that network 200 includes an optical network terminal (ONT) 230 which, in addition to the elements of ONT 132 of network 100, has a status decoder 232 that is connected to controller 142. (Status decoder 232 receives operating power from supply 114 or battery 120, depending on which source is functioning.)

ONT 230 also includes a fourth pair of wires 234 that are directly connected to status decoder 232, and a high pass filter 236 that is connected to status decoder 232 via wires 234. High pass filter 236 can be implemented with, for example, capacitors C3 and C4. In addition, capacitors C3 and C4 are also electrically connected to the second pair of wires 110B of twisted-pair cable 110.

Further, ONT 230 includes a fifth pair of wires 240 that are directly connected to voltage sensor 134 and diode bridge 136, and a low pass filter 242 that is connected to voltage sensor 134 and bridge 136 via wires 240. Low pass filter 242 can be implemented with, for example, inductors L5 and L6. In addition, inductors L5 and L6 are also electrically connected to the second pair of wires 110B of twisted-pair cable 110.

In operation, encoding circuit 214 and the capacitors C1 and C2 of high pass filter 217 output tones onto the second pair of twisted wires 110B that represent the status of the battery. Status decoder 232, which also includes a look up table, detects the tones from status encoder 212, looks up a state that is associated with the detected tone, and passes the state on to controller 142 as battery status information. In addition, high-pass filter 236 blocks the DC voltage from status decoder 232, while low-pass filter 242 blocks the tones from voltage sensor 134 and diode bridge 136.

Table 1 presents an example of a list of possible tone/status combinations. The list can be expanded to include other conditions, such as battery temperature.

TABLE 1

| Tone | Battery Status |
|---|---|
| Tone 1 | Power Supply Providing the Voltage, Replace Battery |
| Tone 2 | Power Supply Providing the Voltage, Battery Uncharged |
| Tone 3 | Power Supply Providing the Voltage, Replace Battery, Battery |
| | Uncharged |
| Tone 4 | Power Supply Providing the Voltage, Battery Good and Charged |
| Tone 5 | Power Supply Providing the Voltage, Battery Good, Battery |
| | Needs Charging |
| Tone 6 | Battery Providing the Voltage, Replace Battery |
| Tone 7 | Battery Providing the Voltage, Battery Uncharged |
| Tone 8 | Battery Providing the Voltage, Replace Battery, Battery |
| | Uncharged |
| Tone 9 | Battery Providing the Voltage, Battery Good and Charged |
| Tone 10 | Battery Providing the Voltage, Battery Good, Battery Needs |
| | Charging |

An alternate method is to generate a unique tone for each status and send multiple tones at the same time, one for each active status. Table 2 presents an example of a list of possible of tone/status pairings. The list can be expanded to include other conditions, such as battery temperature.

TABLE 2

| Tone | Battery Status |
|---|---|
| Tone 1 | Battery Providing the Voltage |
| Tone 2 | Battery Good and Charged |
| Tone 3 | Battery Is Low |
| Tone 4 | Battery Needs Replacing |
| No Tone | No Battery Module Present |

Thus, for example, to provide two pieces of information, such as the battery is good and charged, and providing the voltage, tone 9 from Table 1 can be utilized alone, or tones 1 and 2 from Table 2 can be utilized at the same time.

In the present invention, the battery status tones, along with the power, are placed on a pair of wires (the second pair of wires 110B) that lie adjacent to the telephone wires (the first pair of wires 110A) in twisted-pair cable 110. As a result, it is possible that tone energy from the status tones could couple into the pair of telephone wires, thereby causing interference.

To avoid any question of interference, the tone frequencies that are used can be either below the audible range, such as below 300 Hz, or above the audible range, such as from 8 KHz to 15 KHz. The Continuous Tone Coded Squelch System (CTCSS) provides an example of below-the-audible-range tone generation.

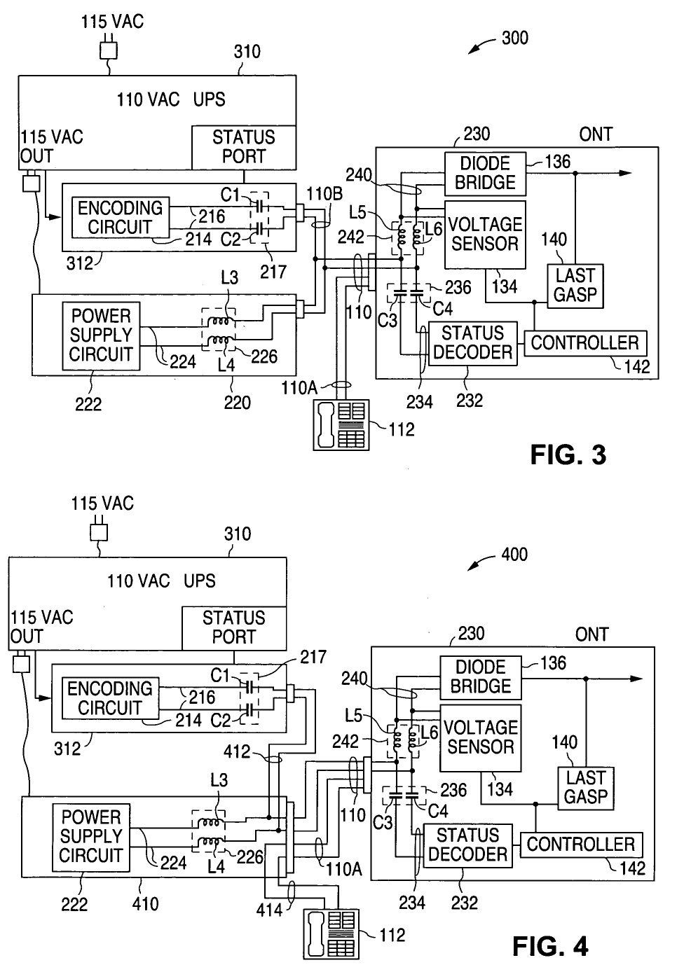

FIG. 3 shows a block diagram that illustrates an example of the subscriber end of a Fiber-To-The-Home (FTTH) network 300 in accordance with an alternate embodiment of the present invention. Network 300 is similar to network 200 and, as a result, utilizes the same reference numerals to designate the structures which are common to both networks.

As shown in FIG. 3, one difference between network 300 and network 200 is that network 300 utilizes an uninterruptible power supply (UPS) 310 and a status encoder 312 in lieu of battery module 210. UPS 310, which includes a battery and a status port that outputs status information regarding the battery, plugs into a standard AC wall outlet, and outputs an AC voltage, such as 115 VAC. In addition, UPS 310 also provides power for the operation of status encoder 312.

Status encoder 312, in turn, can be implemented with and operated the same as status encoder 212, except that status encoder 312 is connected to receive power from UPS 310, and the status port to receive the battery status information from UPS 310. Further, power supply 220 is plugged into UPS 310.

In operation, once power from the AC wall outlet is no longer available, UPS 310 provides 115 VAC to power supply 220 and a DC voltage to status encoder 312 for a period of time via the charge stored in the battery. As a result, power supply 220 and status encoder 312 continue to receive power for the period of time that UPS 310 is able to provide power.

Regardless of whether power is provided via the wall outlet or the battery, status decoder 232 of ONT 230 receives the tones, which represent the battery status information, placed on the second pair of wires 110B by status encoder 312, and decodes the tones from status encoder 312 in the same manner that tones are received and decoded from status encoder 212.

FIG. 4 shows a block diagram that illustrates an example of the subscriber end of a Fiber-To-The-Home (FTTH) network 400 in accordance with an alternate embodiment of the present invention. Network 400 is similar to network 300 and, as a result, utilizes the same reference numerals to designate the structures which are common to both networks.

As shown in FIG. 4, one difference between network 400 and network 300 is that network 400 utilizes a power supply 410 that, in addition to the elements of power supply 220, includes a first connector and a second connector. The first connector is electrically connected to first nodes located between the inductors L3 and L4 and the second pair of wires 110B. The second connector is electrically connected to the first pair of wires 110A.

In addition, network 400 includes a sixth pair of intermediate wires 412 that connect high pass filter 217 to the first node, and a seventh pair of intermediate wires 414 that are connected to the second connector and telephone 112. Although high pass filter 217 is shown as part of status encoder 312, high pass filter 217 can be a part of power supply 410 or an independent device.

Network 400 operates the same as network 300 except that, when only a single RJ-11 (telephone) wall jack is present, power supply 410 can be plugged into the single RJ-11 wall jack, while status encoder 312 and telephone 112 can be plugged into the first and second connectors (e.g., RJ-11 jacks built in to power supply 410) via wires 412 and 414.

It should be understood that the above descriptions are examples of the present invention, and that various alternatives of the invention described herein may be employed in practicing the invention. Thus, it is intended that the following claims define the scope of the invention and that structures and methods within the scope of these claims and their equivalents be covered thereby.

What is claimed is:

1. A network comprising:
a status encoder comprising:
a first pair of wires;
an encoding circuit connected to the first pair of wires, the encoding circuit receiving battery status information, and outputting a plurality of tones that represent battery status to the first pair of wires; and
a high-pass filter connected to the encoding circuit via the first pair of wires.

2. The network of claim 1 wherein the high pass filter includes a pair of capacitors connected to the first pair of wires, and electrically connectable to a second pair of wires.

3. The network of claim 2 wherein the second pair of wires carries a DC voltage, the pair of capacitors superimposing the plurality of tones onto the DC voltage.

4. The network of claim 3 wherein only one tone is output at a time.

5. The network of claim 3 wherein a plurality of tones are output at a same time.

6. The network of claim 1 and further comprising:
a battery that has a battery voltage; and
a control circuit that passes the battery voltage to an output node electrically connected to a second pair of wires, the second pair of wires being electrically coupled to the first pair of wires via the high-pass filter.

7. The network of claim 6 and further comprising:
a low-pass filter connected to the output node;
a voltage sensor connected to the low-pass filter to sense a DC voltage on the output node; and
a controller connected to the encoding circuit, the control circuit, and the voltage sensor, the controller determining a status of the battery, and outputting battery status information to the status encoder.

8. The network of claim 7 and further comprising a power supply electrically connected to the second pair of wires, the power supply placing a DC voltage on the second pair of wires.

9. The network of claim 8 wherein the power supply comprises:
a third pair of wires;
a power supply circuit connected to the third pair of wires, the power supply circuit receiving an AC voltage, converting the AC voltage into a DC voltage, and outputting the DC voltage from the power supply circuit to the third pair of wires; and
a low-pass stage connected to the third pair of wires, and electrically connectable to the second pair of wires to pass the DC voltage onto the second pair of wires, the low-pass stage including a pair of inductors connected to the third pair of wires, and electrically connectable to the second pair of wires, the pair of inductors blocking tones from reaching the power supply circuit.

10. The network of claim 9 and further comprising a twisted-pair cable that has a plurality of pairs of wires that include the second pair of wires.

11. The network of claim 10 and further comprising a network terminal that includes:
an input node electrically connected to the second pair of wires;
a voltage sensor electrically connected to the input node;
a controller connected to the voltage sensor; and
a status decoder electrically connected to the input node, the status decoder receiving the plurality of tones, and outputting battery status information that represents the tones to the controller.

12. The network of claim 1 and further comprising an uninterruptible power supply that has a battery and a status port that outputs the battery status information to the encoding circuit.

13. The network of claim 12 and further comprising:
a second pair of wires;
a third pair of wires;
a power supply circuit connected to the third pair of wires, the power supply circuit receiving an AC voltage, converting the AC voltage into a DC voltage, and outputting the DC voltage from the power supply circuit to the third pair of wires; and
a low-pass filter connected to the third pair of wires, and connectable to the second pair of wires, the second pair of wires being electrically coupled to the first pair of wires.

14. The network of claim 13 and further comprising a twisted-pair cable that has a plurality of pairs of wires that include the second pair of wires.

15. The network of claim 14 and further comprising a network terminal connected to the second pair of wires.

16. The network of claim 15 wherein the network terminal includes:
an input node connectable to the second pair of wires;
a voltage sensor electrically connected to the input node;
a controller connected to the voltage sensor; and
a status decoder electrically connected to the input node, the status decoder receiving the plurality of tones, and outputting battery status information that represents the tones to the controller.

17. A network comprising:
a network terminal comprising:
an input node connectable to a pair of wires,
a voltage sensor electrically connected to an input node; and
a controller connected to the voltage sensor.

18. The network of claim 17 wherein the network terminal further comprises a status decoder electrically connected to the input node, the status decoder receiving a plurality of tones from the input node, and outputting battery status information that represents the tones to the controller.

19. A method of providing battery status information, the method comprising the steps of:
placing a voltage on a pair of wires; and
superimposing a plurality of tones on the voltage on the pair of wires, the plurality of tones representing a status of a battery, the battery switchably providing a voltage to the pair of wires.

20. The method of claim 19 and further comprising the step of detecting the plurality of tones, and determining a battery status from the plurality of tones.
